(19) United States
(12) Patent Application Publication
(10) Pub. No.: US 2021/0365897 A1
(43) Pub. Date: Nov. 25, 2021

(54) INTERCHANGING POINT OF SALE PERIPHERALS

(71) Applicant: Hewlett-Packard Development Company, L.P., Fort Collins, CO (US)

(72) Inventors: SHIVA BANSAL, Pune (IN); RUPESH VIKRAM DEORE, PUNE (IN); Saloni Chourasia, Pune (IN); Sanket Anavkar, Fort Collins, CO (US)

(21) Appl. No.: 17/162,853

(22) Filed: Jan. 29, 2021

(30) Foreign Application Priority Data
Jan. 22, 2020 (IN) 202021002766

(51) Int. Cl. G06Q 10/00; G06F 11/34; G06F 11/30; G07G 1/14

(52) U.S. Cl. CPC G06Q 10/20; G07G 1/14; G06F 11/3041; G06F 11/3433

(57) ABSTRACT

System for monitoring and managing Point of Sale (POS) peripherals is described. The system includes a lifetime estimation engine coupled to a processor to receive peripheral data corresponding to a first set of POS peripherals connected to a first POS terminal and identify an overutilized peripheral from the first set of POS peripherals based on the peripheral data. The overutilized peripheral has an operational-days estimate value below a first threshold value. Further a recommendation engine coupled to the processor may identify an underutilized peripheral from a set of second POS peripherals connected to a second POS terminal such that the underutilized peripheral is of a same peripheral type, wherein the underutilized peripheral has the operational-days estimate value greater than a second threshold value. Further, the recommendation engine provides a recommendation for interchanging the overutilized peripheral and the underutilized peripheral between the first POS terminal and the second POS terminal.

### BACKGROUND

Point of Sale (POS) peripherals are the peripherals associated with POS terminals that are generally used in retail environments, such as shopping centres, malls, and point of sale counters. The POS terminals may be used for various purposes, such as for processing customer transactions and product information in retail environments, scanning tags or bar codes of products, printing invoices or bills, and tracking inventory. Further, each POS terminal may be associated with multiple POS peripherals, such as a touch screen, a keyboard, a mouse, a bar code scanner, and a printer. The POS terminal may control the POS peripherals to process various requests or functionalities in the retail environment.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates a system for managing Point of Sale (POS) peripherals, according to an example implementation of the present subject matter.

FIG. 2 illustrates a POS environment implementing a POS management system, POS terminals, and POS peripherals, according to an example implementation of the present subject matter.

FIG. 3 illustrates a method for interchanging POS peripherals, according to an example implementation of the present subject matter.

FIG. 4 illustrates a method for POS peripherals management, according to another example implementation of the present subject matter.

FIG. 5 illustrates a network environment having a non-transitory computer readable medium for interchanging POS peripherals, according to an example implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Point of Sale (POS) terminals are usually provided at customer interaction points within a retail environment for performing various tasks with the help of connected POS peripherals. For example, POS terminals may use the POS peripherals for processing customer transactions and product information in retail environments, scanning tags or bar codes of products, printing invoices or bills, and tracking inventory. Examples of the POS peripherals may include, but are not limited to, a touch screen, a keyboard, a mouse, a bar code scanner, and a printer.

In a general retail environment, different customer interaction points may have to deal with different number of customers owing to which the POS terminals at each customer interaction point may experience varying usage. For example, some sales or billing counters that are located closer to the entry or exit gate may have to deal with a greater number of customers as compared to the other sales or billing counters that are at comparatively farther locations. Further, the POS terminals may be segregated based on operational functionalities, such as sales, returns, and exchange counters, which may witness varying footfall of customers. For instance, the POS terminals at sales counters may experience larger customer interaction and usage in comparison to POS terminals used at returns or exchange counter.

Therefore, each POS terminal and their POS peripherals may undergo a different degree of utilization, i.e., some of the POS terminals and their POS peripherals may be utilized more as compared to other POS terminals that may remain less utilized. Further, even for the same POS terminal, different POS peripherals may experience different extent or degree of utilization.

With regular utilization, the POS peripherals may experience wear and tear leading to degradation in performance of the POS peripherals. Also, utilization of the POS peripherals up to a lifetime usage value may also lead to malfunctioning or sudden failure of the POS peripherals. The lifetime usage value of a POS peripheral may indicate a maximum operational capacity of the POS peripheral and may be defined by a total number of times the POS peripheral may be used to efficiently and correctly perform an operation. For example, for an ink cartridge of a printer, the lifetime usage value may be defined as a maximum number of pages the printer can print with the print cartridge. For a scanner, the lifetime usage value may be defined as a total number of times the scanner can be used to scan a code. In one example, the lifetime usage value may be specified by a manufacturer of the POS peripheral. Sudden failures in the operation of the POS peripheral towards the end of lifetime usage value may occur at any time, such as when performing a customer transaction, and may thus affect the functioning of the associated POS terminal.

Generally, overall usage details and maintenance requirements of the POS peripherals are monitored for providing recommendations for timely replacement of the POS peripherals. The recommendation is typically generated when performance characteristics of the POS peripheral starts degrading and may indicate to a user that the POS peripheral is to be replaced with a new POS peripheral. However, replacing the POS peripherals with new POS peripherals may not be a cost-effective approach and may increase the overall running cost of each POS terminal as a large inventory may have to be maintained to replace the POS peripherals in case of sudden failure. In some cases, the POS peripherals may be replaced based on the recommendation even if the POS peripherals may still be capable of performing operations, thus leading to wastage of the operational capacity of the POS peripherals.

Further, some POS peripherals may also malfunction if not used regularly. For example, an inkjet printer may not be able to print documents of desired quality due to drying out of the ink in the ink cartridges due to non-utilization of the printer for some duration of time. Similarly, batteries of POS peripherals may discharge if not used regularly. Thus, such POS peripherals may have to be repaired or replaced even though they have not reached the lifetime usage value. Thus, underutilization of the POS peripherals may also increase the maintenance cost and wastage of resources, such as the POS peripherals.

The present subject matter discloses a system for managing POS peripherals interchange. In one example, the systems, such as a POS management system may monitor and manage a plurality of POS peripherals, each connected to one or more POS terminals. The system identifies overutilized peripherals and underutilized peripherals of a same peripheral type based on peripheral data received from the POS peripherals. The system further provides a recommendation for interchanging the overutilized peripheral and the underutilized peripheral between the POS terminal associated with the overutilized peripheral and the POS terminal associated with the underutilized peripheral.

In one example implementation of the present subject matter, a system for managing POS peripherals is disclosed. The system comprises a lifetime estimation engine for determining a POS peripheral as an underutilized or an overutilized device. The lifetime estimation engine receives peripheral data corresponding to a plurality of POS peripherals, each connected to a first POS terminal. The peripheral data may include a current usage count, an operational-days count, and a lifetime usage value. The current usage count may represent the total number of times the POS peripheral has been operated since installation. The operational-days count may represent the total number of days for which the POS peripheral has been operational. The lifetime usage value may indicate a total number of times the POS peripheral may be effectively used or operated before failure. Based on the peripheral data, the lifetime estimation engine may identify an overutilized peripheral from a first set of POS peripherals connected to the first POS terminal. The overutilized peripheral has an operational-days estimate value below a first threshold value. In one example, the first threshold value may represent a minimum number of days for which a POS peripheral is estimated to remain operational, before exceeding the lifetime usage value, to qualify as an average-utilized peripheral.

Further, the system comprises a recommendation engine to identify an underutilized peripheral and provide a recommendation for interchanging the overutilized peripheral with the underutilized peripheral between the POS terminals. The recommendation engine may identify an underutilized peripheral, of a same peripheral type as the overutilized peripheral, from a second set of POS peripherals that may be connected to another POS terminal, say, a second POS terminal. The underutilized peripheral has the operational-days estimate value greater than a second threshold value. In one example, the second threshold value may indicate a maximum number of days for which a POS peripheral is estimated to remain operational, before exceeding the lifetime usage value, to qualify as an average-utilized peripheral. Further, the recommendation engine may provide a recommendation for interchanging the overutilized peripheral and the underutilized peripheral between the first POS terminal and the second POS terminal.

The present subject matter thus facilitates a cost-effective monitoring and maintenance of POS peripherals, allowing effective usage of the POS peripherals up to their full capacity. Monitoring the usage characteristics and life expectancy of the POS peripherals helps the system in determining the overutilized peripherals and the underutilized peripherals. The system may accordingly provide a recommendation to interchange the overutilized peripherals and the underutilized peripherals, thereby allowing a rotation of the POS peripherals within a POS environment as per usage of the POS peripherals. Such a rotation of existing POS peripherals facilitates in reducing the cost involved in replacing existing POS peripherals with new POS peripherals. Allowing interchange of the overutilized peripheral with the underutilized peripheral further facilitates in reducing the cost involved in maintaining an inventory of replacement POS peripherals for the existing POS peripherals.

Further, by interchanging the POS peripherals, the operational life of the POS peripherals may be increased as the average daily usage count of the POS peripherals may be selectively varied. For example, the average daily usage count of an overutilized peripheral may be reduced by associating the overutilized peripheral with a less utilized POS terminal, thereby, increasing the operational life of the overutilized peripherals. Similarly, the average daily usage count of an underutilized peripheral may be increased by associating the underutilized peripheral with a regularly utilized POS terminal, thereby preventing the underutilized peripherals or their parts from getting damaged due to non-usability. For example, interchanging an overutilized printer with an underutilized printer may ensure that the underutilized printer is regularly used, thus preventing drying out of ink.

Further, regular monitoring of the usage of the peripherals may facilitate in providing regular updates regarding health and utilization characteristics of a POS peripheral to a user to prevent failures or overutilization situations beforehand. Providing recommendations with information about duration or number of days for which the POS peripheral may still be used before crossing the lifetime usage value, may help in avoiding urgent requirements to replace the POS peripheral. Thus, the present subject matter helps in preventing sudden failure of the peripherals which may otherwise result in bad customer experience.

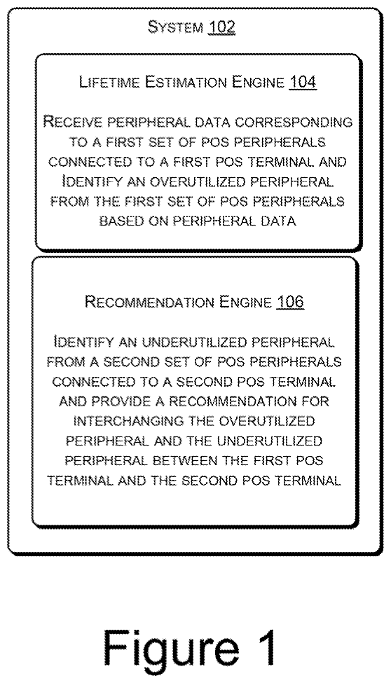

The present subject matter is further described with reference to FIGS. 1 to 5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 102, according to an example implementation of the present subject matter. In one example of the present subject matter, the system 102 may be implemented in a Point of Sale (POS) environment to monitor and manage POS peripherals (not shown in this figure) implemented in the POS environment. The system 102 may be implemented either as a stand-alone system or as a distributed computing system having one or more physical computing systems geographically distributed at same or different locations. In one example implementation, the system 102 may be implemented on each POS terminal (not shown in this figure) implemented in the POS environment to monitor and manage the POS peripherals associated with the POS terminal. In another example implementation, the system 102 may be implemented on a server, such as a POS management system (not shown in this figure) to monitor and manage a plurality of POS peripherals implemented in the POS environment. In yet another example implementation, the system 102 may be implemented on the POS terminal and the POS management system.

Examples of the system 102 may include, but are not limited to, POS systems, desktop computers, laptops, tablets, portable computers, workstation, mainframe computer, servers and network servers. Examples of the POS peripherals include, but are not limited to, a touch screen, a keyboard, a mouse, a bar code scanner, and a printer.

In one implementation, the system 102 may include a lifetime estimation engine 104 to receive peripheral data corresponding to a first set of POS peripherals connected to a first POS terminal. In one example, the peripheral data may include a current usage count of the peripheral, an operational-days count, and a lifetime usage value of the peripheral. The lifetime usage value of the POS peripheral may indicate a total number of times or counts for which a POS peripheral of the same peripheral type may be successfully operated or used. In one example, the lifetime usage value may be provided by the manufacturer and stored in the peripheral as metadata. The current usage count may represent a total number of times the POS peripheral has been operated since installation. The operational-days count may represent the total number of days for which the POS peripheral has been operational.

The lifetime estimation engine 104 may identify an overutilized peripheral from the first set of POS peripherals based on the peripheral data. In one example, the overutilized peripheral may have an operational-days estimate value below a first threshold value. The operational-days estimate value may indicate the remaining number of days for which the POS peripheral is estimated to remain operational before exceeding the lifetime usage value. In one example, operational-days estimate value may be determined based on based on the average daily usage count, the current usage count, and the lifetime usage value of the POS peripheral. The first threshold value may indicate a minimum number of days for which a POS peripheral is estimated to remain operational, before exceeding the lifetime usage value, to qualify as an average-utilized peripheral.

For instance, if for a POS peripheral the operational days-estimate value is determined to be 8, then it may be estimated that POS peripheral may stop working after 8 days if the POS peripheral remains connected to the same POS terminal. Further, if the first threshold value is defined as 10 days, then any POS peripheral having an operational-days estimate value of less than 10 days may be determined to be overutilized. Thus, in the present example, the POS peripheral may be identified as an overutilized peripheral by the lifetime estimation engine 104.

The system 102 may further include a recommendation engine 106 to identify an underutilized peripheral from a second set of POS peripherals connected to a second POS terminal. The underutilized peripheral may be of the same type as the overutilized peripheral. In one example, the underutilized peripheral has the operational-days estimate value greater than a second threshold value. In one example, the second threshold value may indicate a maximum number of days for which a POS peripheral is estimated to remain operational, before exceeding the lifetime usage value, to qualify as an average-utilized peripheral. For example, the second threshold value may be defined as 150 days, indicating that any POS peripheral having an operational-days estimate value of more than 150 days is underutilized.

Subsequently, the recommendation engine 106 may provide a recommendation for interchanging the overutilized peripheral and the underutilized peripheral between the first POS terminal and the second POS terminal.

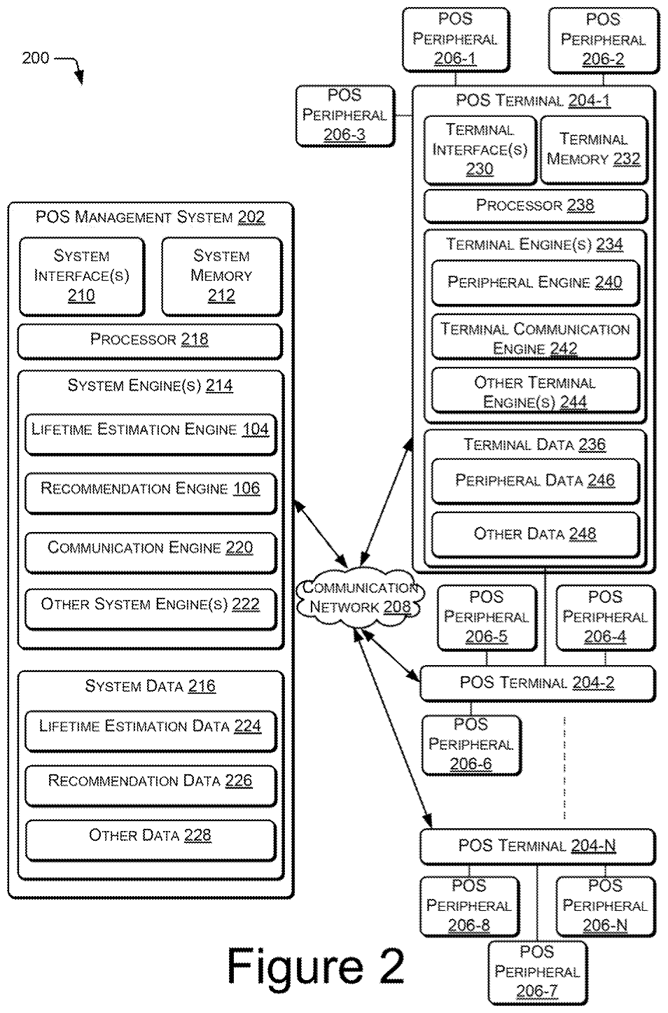

FIG. 2 illustrates a POS environment 200 implementing a POS management system, a plurality of POS terminals, and a plurality of POS peripherals, according to an example implementation of the present subject matter. Examples of the POS environment 200 include, but are not limited to, shopping centers, malls, food courts, and point of sale counters. The POS environment 200 may include a POS management system 202, a plurality of POS terminals 204-1, 204-2, and 204-N, and a plurality of POS peripherals 206-1, 206-2, 206-3, 206-4, 206-5, 206-6, 206-7, 206-8, . . . 206-N. The POS terminals 204-1, 204-2, and 204-N may be individually referred to as a POS terminal 204 and collectively referred to as POS terminals 204. The POS peripherals 206-1, 206-2, 206-3, 206-4, 206-5, 206-5, 206-7, 206-8, . . . 206-N may be individually referred to as a POS peripheral 206 and collectively referred to as POS peripherals 206.

Examples of the POS management system 202 include, but are not limited to, POS systems, desktop computers, laptops, tablets, portable computers, workstation, mainframe computer, servers, and network servers. In an example, the POS management system 202 may implement the system 102 as described in FIG. 1. In one example implementation, the POS management system 202 may be implemented as a distributed computing system having one or more physical computing systems geographically distributed at different or same geographical locations. Further, in an example implementation, the system 102 may be implemented on either or both the POS management system 202 and the POS terminals 204. The present approaches may also be implemented in other types of POS management system 202 and POS terminal 204 without deviating from the scope of the present subject matter.

The POS terminals 204 may be provided at customer interaction points within the POS environment 200 for performing various tasks with the help of the attached POS peripherals 206. For example, the POS terminals 204 may use the POS peripherals 206 for processing customer transactions and product information in retail environments, scanning tags or bar codes of products, printing invoices or bills, and tracking inventory. Examples of the POS peripherals 206 include, but are not limited to, a touch screen, a keyboard, a mouse, a bar code scanner, and a printer.

In one example implementation, the POS management system 202 may be communicatively coupled to the POS terminals 204 over a communication network 208. The communication network 208 may be a wireless network, a wired network, or a combination thereof. The communication network 208 may also be an individual network or a collection of many such individual networks, interconnected with each other and functioning as a single large network, e.g., the Internet or an intranet. The communication network 208 can be one of the different types of networks, such as intranet, local area network (LAN), wide area network (WAN), and the internet. In an example, the communication network 208 may include any communication network that uses any of the commonly used protocols, for example, Hypertext Transfer Protocol (HTTP), and Transmission Control Protocol/Internet Protocol (TCP/IP).

The POS management system 202 includes system interface(s) 210 and system memory 212. The system interface(s) 210 may include a variety of interfaces, for example, interfaces for data input and output devices, referred to as I/O devices, storage devices, network devices, and the like. The system interface(s) 210 may facilitate communication between the POS management system 202, the POS terminal 204, and various other computing devices connected in the POS environment 200. The system interface(s) 210 may also provide a communication pathway for one or more components of the POS management system 202. Examples of such components may include, but are not limited to, input device, such as keyboards and a touch enabled graphical user interface.

The system memory 212 may store one or more computer-readable instructions, which may be fetched and executed to provide print interfaces to users for providing print instructions. The system memory 212 may include any non-transitory computer-readable medium including, for example, volatile memory such as Random Access Memory (RAM), or non-volatile memory such as Erasable Programmable Read-only Memory (EPROM), flash memory, and the like. The POS management system 202 further includes system engine(s) 214 and system data 216.

The system engine(s) 214 may be implemented as a combination of hardware and programming (for example, programmable instructions) to implement one or more functionalities of the system engine(s) 214. In examples described herein, such combinations of hardware and programming may be implemented in several different ways. For example, the programming for the system engine(s) 214 may include processor executable instructions stored on a non-transitory machine-readable storage medium and the hardware for the system engine(s) 214 may include a processing resource to execute such instructions. In one example, the system engine(s) 214 may further be coupled to processor(s) 218 of the POS management system 202 to execute the functionalities of the system engine(s) 214. The processor(s) 218 may include microprocessors, microcomputers, microcontrollers, digital signal processors, central processing units, state machines, logic circuitries, and/or any other devices that manipulate signals and data based on computer-readable instructions.

In the present examples, the machine-readable storage medium may store instructions that, when executed by the processing resource, may implement system engine(s) 214. In such examples, the POS management system 202 may include the machine-readable storage medium storing the instructions and the processing resource to execute the instructions, or the machine-readable storage medium may be separate but accessible to the POS management system 202 and the processing resource. In other examples, system engine(s) 214 may be implemented by electronic circuitry. The system engine(s) 214 may further include circuitry and hardware for monitoring operations.

The system data 216 may include data that is either stored or generated as a result of functionalities implemented by any of the system engine(s) 214. The system engine(s) 214 of the POS management system 202 may include the lifetime estimation engine 104, the recommendation engine 106, the communication engine 220, and other system engine(s) 222. The other system engine(s) 222 may implement functionalities that supplement applications or functions performed by the system engine(s) 214. Further, the system data 216 may include lifetime estimation data 224, recommendation data 226, and other system data 228.

Further, each of the POS terminal 204 may include terminal interface(s), terminal memory, terminal engine(s), and terminal data. However, for the sake of brevity, and not as a limitation, the terminal interface(s), terminal memory, terminal engine(s), and the terminal data are illustrated only in the POS terminal 204-1, interchangeably referred to as a first POS terminal 204-1.

The POS terminal 204-1 may include terminal interface(s) 230 and terminal memory 232. The terminal interface(s) 230 may include a variety of interfaces, for example, interfaces for data input and output devices, referred to as input/output (I/O) devices, storage devices, network devices, and the like. The terminal interface(s) 230 may facilitate communication between the POS management system 202, the POS terminal 204, the POS peripherals 206, and various other computing devices connected in a networked environment. The terminal interface(s) 230 may also provide a communication pathway for one or more components of the POS terminal. Examples of such components may include, but are not limited to, input device, such as keyboards and a touch enabled graphical user interface.

The terminal memory 232 may store one or more computer-readable instructions, which may be fetched and executed to provide print interfaces to users for providing print instructions. The terminal memory 232 may include any non-transitory computer-readable medium including, for example, volatile memory such as RAM, or non-volatile memory such as EPROM, flash memory, and the like. The POS terminal 204-1 further includes terminal engine(s) 234 and terminal data 236.

The terminal engine(s) 234 may be implemented as a combination of hardware and programming (for example, programmable instructions) to implement one or more functionalities of the terminal engine(s) 234. In examples described herein, such combinations of hardware and programming may be implemented in several different ways. For example, the programming for the terminal engine(s) 234 may include processor executable instructions stored on a non-transitory machine-readable storage medium and the hardware for the terminal engine(s) 234 may include a processing resource to execute such instructions. In one example, the terminal engine(s) 234 may further be coupled to processor(s) 238 of the POS terminal 204 to execute the functionalities of the terminal engine(s) 234. The processor(s) 238 may include microprocessors, microcomputers, microcontrollers, digital signal processors, central processing units, state machines, logic circuitries, and/or any other devices that manipulate signals and data based on computer-readable instructions.

In the present examples, the machine-readable storage medium may store instructions that, when executed by the processing resource, implement terminal engine(s) 234. In such examples, the POS terminal 204-1 may include the machine-readable storage medium storing the instructions and the processing resource to execute the instructions, or the machine-readable storage medium may be separate but accessible to the POS terminal 204-1 and the processing resource. In other examples, terminal engine(s) 234 may be implemented by electronic circuitry. The terminal engine(s) 234 may further include circuitry and hardware for monitoring operations. The terminal data 236 may include data that is either stored or generated as a result of functionalities implemented by any of the terminal engine(s) 234.

Further the terminal engine(s) 234 may include a peripheral engine, a terminal communication engine, and other terminal engine(s). The other terminal engine(s) may implement functionalities that supplement applications or functions performed by the terminal engine(s) 234. Further, terminal data 236 may include peripheral data and other data. For instance, the terminal engine(s) 234 of the POS terminal 204-1 may include a peripheral engine 240, a terminal communication engine 242, and other terminal engine(s) 244. The terminal data 236 may include peripheral data 246 and other data 248.

As previously discussed, the POS management system 202 may monitor the POS peripherals 206 connected to the POS terminals 204 to determine a degree of utilization of each of the POS peripherals 206. Based on the degree of utilization, the POS management system 202 may determine whether the POS peripheral 206 is overutilized, underutilized, or average-utilized. The overutilized peripheral may be defined as a POS peripheral having a short remaining operational life, say, 8 days remaining owing to a high usage since installation in the POS environment 200. The underutilized peripheral may be defined as a POS peripheral having a long remaining operational life, say, 100 days remaining owing to less usage since installation in the POS environment 200. The average-utilized peripheral may be defined as a POS peripheral having a moderate remaining operational life remaining owing to moderate usage since installation in the POS environment 200.

In operation, once the POS peripherals 206 and the POS terminals 204 are implemented in the POS environment 200, the peripheral engine 240 may start monitoring the POS peripherals 206 connected to the POS terminal 204. In one example, at the time the POS peripheral 206 is installed, the POS terminal 204 may record identification data corresponding to the POS peripheral 206. The identification data may include driver version of the POS peripheral 206, manufacturer name of the POS peripheral 206, device name of the POS peripheral 206, and a unique identifier of the POS peripheral 206. The POS terminal 204 may further save an installation date indicating the date on which the POS peripheral 206 was installed at the POS terminal 204. The POS terminal 204 may further save a lifetime usage value for each POS Peripheral 206 indicating the total number of times or counts for which POS peripherals 206 of the same peripheral type may be successfully operated on an average. In one example, the lifetime usage value may be provided by the manufacturer and stored in the peripheral as a metadata. In another example, the POS terminal 204 may determine a lifetime usage value of the POS peripheral 206 based on the failure rate of the POS peripherals 206 connected to the POS management system 202. The POS terminal 204 may save the identification data, the installation date, and the lifetime usage value in the peripheral data 246.

In one example, the peripheral engine 240 may maintain a current usage counter in the peripheral data 246 to monitor and record a count of the usage of the POS peripheral 206 from the installation date of the POS peripheral 206. The peripheral engine 240 may further maintain an operational-days counter to monitor and record a count of the total number of days for which the peripheral has been operational after installation. In one example, the current usage count may be increased by 1 upon each instance of a successful usage of the POS peripheral 206. Similarly, the operational-days count may be increased by 1 on each operational day.

In another example, the POS peripheral 206 may maintain the current usage count and the operational-days count using inbuilt functionalities of the POS peripheral 206. In said example, the POS peripheral 206 may share the current usage count and the operational-days count with the peripheral engine 206 at predefined intervals, such as on an hourly basis, twice a day, once a day, and the like. Alternatively, the POS peripheral 206 may share the current usage count and the operational-days count with the peripheral engine 240 when requested by the peripheral engine 240.

In one example, the peripheral engine 240 may store the current usage count and the operational-days count in the peripheral data 246 for further processing. For instance, the terminal communication engine 242 of the POS terminal 204 may share the peripheral data with the communication engine 220 over the communication network 208. In one example, the communication engine 220 may store the peripheral data in the lifetime estimation data 224 for further analysis. In one example, the POS terminal 204 may share the peripheral data with the POS management system 202 at regular intervals, such as on an hourly basis or daily basis. For example, the POS terminal 204 may share the peripheral data with the POS management system 202 every hour or twice a day or once a day, say at the beginning or end of a day. In another example implementation, the POS terminal 204 may share the peripheral data with the POS management system 202 when requested by the POS management system 202.

Upon receiving the peripheral data, the lifetime estimation engine 104 of the POS management system 202 may analyze the peripheral data to identify whether the POS peripheral 206 is an underutilized, overutilized or average-utilized. In one example, for each of the POS peripherals 206, the lifetime estimation engine 104 may calculate an average daily usage count based on the current usage count of the POS peripheral 206 and the operational-days count of the POS peripheral 206. In one example, the average daily usage count may indicate an average number of times the POS peripheral 206 may be used on a single day of operation. As discussed earlier, the current usage count may indicate the total number of times the POS peripheral 206 has been operated from the installation date. The operational-days count may indicate that total number of days for which the POS peripheral 206 has been operational since installation. In one example, the average daily usage count may be calculated by dividing the current usage count with the operational-days count. For example, for a POS peripheral 206 having a current usage count of 6000 and operational-days count of 30 days, the average daily usage count may be calculated to be 200 uses/day.

Based on the average daily usage count, the current usage count, and the lifetime usage value of the peripheral, the lifetime estimation engine 104 may calculate the operational-days estimate value for each POS peripheral 206. In one example, the operational-days estimate value may indicate a number the remaining number of days for which the POS peripheral 206 is estimated to remain operational before exceeding the lifetime usage value. In one example, the lifetime estimation engine 104 may initially calculate a remaining number of usage counts by subtracting the current usage count from the lifetime usage value of the peripheral. In one example, the remaining number of lifetime usage counts may indicate the number of times for which the POS peripheral 206 may be used before exceeding the lifetime usage value of the peripheral. The lifetime estimation engine 104 may subsequently calculate the operational-days estimate value by dividing the remaining number of lifetime usage counts with the average daily usage count.

With reference to the previous example, if the POS peripheral 206 has the lifetime usage value of 50000, the average daily usage count of 200 uses/day, and the current usage count of 6000, the operational-days estimate value may be calculated as ((50000−6000)/200)=220. Thus, it may be estimated that the POS peripheral 206 may be operated for the next 220 days before malfunctioning, if operated at the same rate equal to the average daily usage count.

Subsequently, for each of the POS peripherals 206, the lifetime estimation engine 104 may compare the operational-days estimate value of the POS peripheral 206 with a first threshold value and a second threshold value to determine whether the POS peripheral 206 is overutilized, underutilized, or average utilized. As previously described, the first threshold value may indicate a minimum number of days for which the POS peripheral 206 may be estimated to remain operational, before exceeding the lifetime usage value, to qualify as an average-utilized peripheral. The second threshold value may indicate a maximum number of days for which the POS peripheral 206 may be estimated to remain operational, before exceeding the lifetime usage value, to qualify as an average-utilized peripheral. In one example, the first threshold value may be in a range of 8-15 days and the second threshold value may be in the range of 80-120.

If it is determined that the POS peripheral 206 has the operational-days estimate value greater than the second threshold value, the POS peripheral may be identified as an underutilized peripheral. If it is determined that the POS peripheral 206 has the operational-days estimate value between the first threshold and the second threshold, the POS peripheral 206 may be determined as an average-utilized peripheral. The lifetime estimation engine 104 may accordingly recommend continued usage of the average-utilized peripheral associated with the POS terminal 204, for example, the first the POS terminal 204-1.

If it is determined that the POS peripheral 206 has the operational-days estimate value below the first threshold value, the POS peripheral may be identified as an overutilized peripheral. In one example, the lifetime estimation engine 104 may save a status indicting a degree of utilization of the POS peripheral 206 in the lifetime estimation data 224 as indicated in the Table 1 below. The table 1 illustrates an exemplary list of POS peripherals 206 and associated information including the status indicting the degree of utilization. As an example, the degree of utilization has been calculated for first threshold value of 20 and the second threshold value of 80. In one example, the table 1 may be associated with a time stamp and may be regularly updated, for instance, upon any change in the PoS POS environment 200 or periodically to update the degree of utilization.

TABLE 1

| POS | Peripheral | Operational-days | Degree of |
|---|---|---|---|
| Peripheral | Type | estimate | utilization |
| 206-1 | Mouse | 110 | Underutilized |
| 206-2 | Scanner | 9 | Overutilized |
| 206-3 | Display | 50 | Average-utilized |
| 206-4 | Scanner | 100 | Underutilized |
| 206-5 | Printer | 60 | Average-utilized |
| 206-6 | Keyboard | 90 | Underutilized |
| 206-7 | Display | 15 | Overutilized |
| 206-8 | Mouse | 105 | Underutilized |
| 206-N | Scanner | 55 | Average-utilized |

As illustrated in table 1, the POS peripheral 206-1 of the POS terminal 204-1 may be underutilized, the POS peripheral 206-2 may be overutilized, and the POS peripheral 206-3 may be average-utilized. Similarly, the lifetime estimation engine 104 may determine the degree of usability for other POS terminals 204 as well. For example, the POS peripheral 206-4, 206-5, and 206-6 of the POS terminal 204-2 may be determined to be underutilized, average-utilized, and underutilized respectively. Further, the POS peripheral 206-7, 206-8, and 206-N of the POS terminal 204-N may be overutilized, underutilized, and average-utilized, respectively. Thus, the lifetime estimation engine 104 may determine an overutilized peripheral from the first set of POS peripherals 206 based on the peripheral data. For example, the lifetime estimation engine 104 may determine the POS peripheral 206-2 of the POS terminal 204-1 as an overutilized peripheral.

Subsequently, the recommendation engine 106 may identify the peripheral type for the overutilized peripheral identified from the first set of POS peripherals. The recommendation engine 106 may accordingly obtain a list of POS peripherals 206 of the same peripheral type as the overutilized peripheral, associated with POS terminals 204 other than the first POS terminal 204-1. For example, the recommendation engine 106 may identify that the POS peripheral 206-2 is a scanner and may thus obtain a list of POS peripherals of the peripheral type scanner. For example, the recommendation engine 106 may identify the POS peripheral 206-4 associated with POS terminal 204-2 and the POS peripheral 206-N associated with the POS terminal 204-N to be of the peripheral type scanner.

The recommendation engine 106 may further identify the underutilized peripherals from the list of the POS peripherals 206. In one example, the recommendation engine 106 may compare the operational-days estimate value of the identified POS peripheral 206 with the second threshold value to identify underutilized peripheral of the same peripheral type as the overutilized peripheral. In another example, the recommendation engine 106 may identify the underutilized peripheral from the list of POS peripherals 206 based on the degree of utilization determined by the lifetime estimation engine 104, as illustrated in Table 1. In one example, the recommendation engine 106 may identify the POS peripheral 206-4 from the second set of POS peripherals 206 connected to a second POS terminal 204-2 as the underutilized peripheral.

The recommendation engine 106 may accordingly provide a recommendation for interchanging the overutilized peripheral and the underutilized peripheral between the first POS terminal 204-1 and the second POS terminal 204-2. For instance, the recommendation engine 106 may recommend that the POS peripheral 206-4 currently associated with the second POS terminal 204-2 may be associated with the first POS terminal 204-1. Further, the POS peripheral 206-2 currently associated with the first POS terminal 204-1 may be associated with the second POS terminal 204-2.

In one example, if it is determined that no underutilized peripheral of the same peripheral type is associated with other POS terminals 204, the recommendation engine 106 may ascertain if a POS peripheral 206 of the same peripheral type is available in an inventory of the POS environment 200. The recommendation engine 106 may accordingly recommend replacing the overutilized peripheral with the POS peripheral 206 available in inventory.

In another example, if it is determined that no underutilized peripheral of the same peripheral type is available in the inventory of the POS environment 200, the recommendation engine 106 may recommend ordering a new POS peripheral 206 for replacing the overutilized peripheral. In one example, the recommendation may be provided in the form of an audio/video message. In another example, the recommendation may be provided in various forms, such as a notification, a pop-up message, and an email. Further, the recommendation may be provided to the POS terminal 204 or the POS management system 202 or to a user device of user or the administrator of the POS management system 202.

In one example, the recommendation engine 106 may also provide various reports in the form of graphical outputs or visualization charts, such as pie charts, bar charts, graphs, and scatter plots. The reports may indicate health and user statistics of the POS peripherals 206 connected to the POS terminals 204 installed in the POS environment 200, that may enable a user or an administrator to monitor health of the POS peripherals 206.

Further, the report may indicate the number of days after which an overutilized peripheral may be interchanged with an underutilized peripheral of the same peripheral type. The report may also indicate availability of POS peripherals in the inventory or may recommend for ordering new POS peripheral 206 for interchanging overutilized peripheral with an underutilized peripheral.

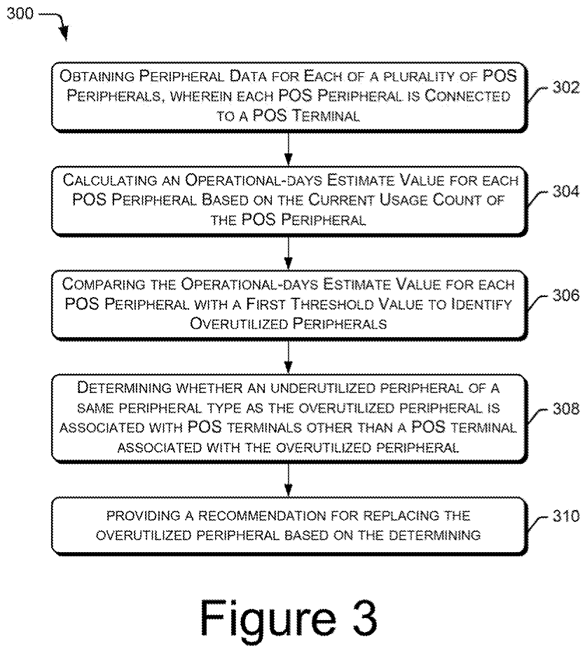

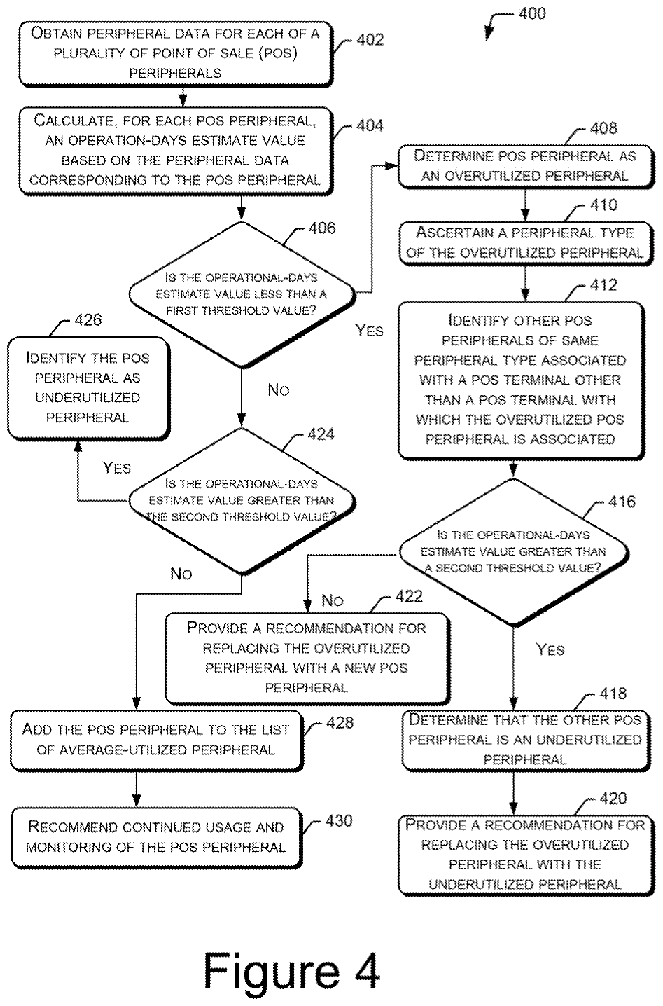

FIGS. 3 and 4 illustrate example methods 300 and 400, respectively, for POS peripherals management. The order in which the methods are described is not intended to be construed as a limitation, and any number of the described method blocks may be combined in any order to implement the methods, or an alternative method. Furthermore, methods 300 and 400 may be implemented by processing resource or computing device(s) through any suitable hardware, non-transitory machine readable instructions, or combination thereof.

It may also be understood that methods 300 and 400 may be performed by programmed computing devices, such as the POS management system 202 and the POS terminals 204, as depicted in FIGS. 1-2. Furthermore, the methods 300 and 400 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 300 and 400 are described below with reference to the POS management system 202 and the POS terminals 204 as described above; other suitable systems for the execution of these methods may also be utilized. Additionally, implementation of these methods is not limited to such examples.

FIG. 3 illustrates a method 300 for POS peripherals management, according to an example implementation of the present subject matter. At block 302, peripheral data is obtained for each of a plurality of POS peripherals. In one example, each POS peripheral is connected to a POS terminal, from among a plurality of POS terminals. In one example implementation, a lifetime estimation engine such as the lifetime estimation engine 104 of the POS management system 202 may receive the peripheral data from the POS terminals 204 on regular intervals. In another example implementation, the peripheral data corresponding to the POS peripherals may be sent by POS terminals upon receiving a request form the lifetime estimation engine.

In one example, the peripheral data of the POS peripheral may include at least a current usage count of the POS peripheral, an operational-days count of the POS peripheral, a peripheral type of the POS peripheral, and a lifetime usage value of the POS peripheral.

At block 304, an operational-days estimate value for each POS peripheral 206 is calculated. In one example, the operational-days estimate value may be calculated based on the current usage count, the operational-days count, and the lifetime usage value of the POS peripheral. Initially, for each POS peripheral, an average daily usage count may be determined based on the current usage count and the operational-days count. Subsequently, the operational-days estimate value for each POS peripheral may be calculated based on the average daily usage count, the current usage count, and the lifetime usage value of the POS peripheral.

In one example, the operational-days estimate value may indicate the remaining number of days for which the POS peripheral 206 may be estimated to remain operational before exceeding the lifetime usage value.

At block 306, the operational-days estimate value for each of the POS peripherals is compared with a first threshold value to identify overutilized peripherals. In one example implementation, the lifetime estimation engine may compare the operational-days estimate value with a first threshold value and a second threshold value to determine whether the POS peripheral is overutilized, underutilized, or average utilized. If it is determined that the POS peripheral has the operational-days estimate value between the first threshold and the second threshold, the POS peripheral 206 may be determined as an average-utilized peripheral.

If the POS peripheral has the operational-days estimate value below the first threshold value, the POS peripheral may be identified as an overutilized peripheral. If the POS peripheral is determined to have the operational-days estimate value greater than the second threshold value, the POS peripheral may be identified as an underutilized peripheral.

At block 308, it is determined if an underutilized peripheral of a same peripheral type as the overutilized peripheral is associated with a POS terminal other than the POS terminal 204 associated with the overutilized peripheral. In one example, a recommendation engine such as the recommendation engine 106 of the POS management system 202 may identify the underutilized peripheral. Initially, a peripheral type of each of the overutilized peripheral may be determined. Subsequently, for each overutilized peripheral, other POS peripherals of the same peripheral type may be identified such that the other POS peripherals are associated with POS terminals other than the POS terminal associated with the overutilized peripheral.

At block 310, a recommendation for replacing the overutilized peripheral may be provided based on the determining. In one implementation, the recommendation may suggest replacing the overutilized peripheral with the underutilized peripheral. In one example, the recommendation may be provided as a notification, a pop-up message or an email message to a user or an administrator of the POS environment or the POS terminal. Further, the recommendation may be provided on a display of the POS terminal or the POS management system or a user device of the administrator.

FIG. 4 illustrates a method 400 for POS peripherals management, according to another example implementation of the present subject matter. At block 402, peripheral data for each of a plurality of POS peripherals may be obtained. In one example implementation, the lifetime estimation engine 104 may receive the peripheral data from the POS terminals 204. As previously described, the peripheral data for each of the POS peripheral may include at least the current usage count, the operational-days count, and the lifetime usage value of the POS peripheral.

At block 404, an operational-days estimate value may be calculated for each POS peripheral based on the peripheral data corresponding to the POS peripheral. As described above, the operational-days estimate value may indicate the remaining number of days for which the POS peripheral may be estimated to remain operational before exceeding the lifetime usage value. In one implementation, the lifetime estimation engine 104 may analyze the peripheral data and calculate the average daily usage count based on the current usage count and the operational-days count of the POS peripheral. In one example, the average daily usage count may indicate an average number of times the POS peripheral may be used on a single day of operation. Further, the operational-days estimate value for each POS peripheral may be calculated based on the average daily usage count, the current usage count, and the lifetime usage value of the POS peripheral.

At block 406, it is determined if the operational-days estimate value is less than a first threshold value. In one example, the first threshold value may indicate a minimum number of days for which the POS peripheral may be estimated to remain operational before exceeding the lifetime usage value to qualify as an average-utilized peripheral. If it is determined that the operational-days estimate value of the POS peripheral is less than the first threshold value (yes path), the POS peripherals 206 may be determined as an overutilized peripheral at block 408.

At block 410, peripheral type for the overutilized peripherals is ascertained. In one example implementation, a peripheral type of the overutilized peripherals may be ascertained using peripheral data corresponding to the overutilized peripheral. The peripheral type may indicate the type of the POS peripheral, for example, a scanner, mouse, keyboard, and a printer.

At block 412, other POS peripherals of the same peripheral type as the overutilized peripheral are identified. In one example, the other POS peripherals of the same peripheral type may be associated with POS terminals other than the POS terminal with which the overutilized peripheral is associated.

At block 416, it is determined if the operational-days estimate value of the identified other POS peripheral is greater than a second threshold value. If it is determined that the operational-days estimate value of the identified other POS peripherals is greater than the second threshold value (yes path), the POS peripherals 206 may be determined as an underutilized peripheral at block 418.

At block 420, a recommendation for replacing the overutilized peripheral with the underutilized peripheral may be provided. In one implementation, a recommendation engine such as the recommendation engine 106 may provide a recommendation for replacing the overutilized peripheral with the underutilized peripheral. Further, the overutilized peripheral may be associated with the POS terminal with which the underutilized peripheral was earlier associated. In one example, the recommendation may be provided as a notification, pop-up message or an email message to a user or an administrator on a display of the POS terminal or the POS management system or a user device an administrator of the POS environment 200.

If at block 416, it is determined that the operational-days estimate value of the identified other POS peripherals is less than the second threshold value (No path), it is determined that no underutilized peripheral of the same peripheral type as the overutilized peripheral is available. A recommendation for replacing the overutilized peripheral with a new POS peripheral is provided at block 422. In one example, a recommendation for replacing the overutilized peripheral with a POS peripheral available in the inventory may be provided. In another example, a recommendation for ordering a new POS peripheral for replacing the overutilized may be provided if no peripheral of the same peripheral type is available in the inventory.

If at block 406, it is determined that the operational-days estimate value of the POS peripheral is greater than the first threshold value (No path) the POS peripherals, it is determined at block 424 if the operational-days estimate value of the POS peripherals is greater than the second threshold value. If it is determined that the operational-days estimate value of the POS peripherals is greater than the second threshold value (Yes path), the POS peripherals is determined as an underutilized peripheral at block 426.

If it is determined that the operational-days estimate value of the identified other POS peripherals is less than the second threshold value (No path), the POS peripherals 206 is determined as an average-utilized peripheral at block 428.

At block 430, a recommendation for continued usage and monitoring of the POS peripheral may be provided.

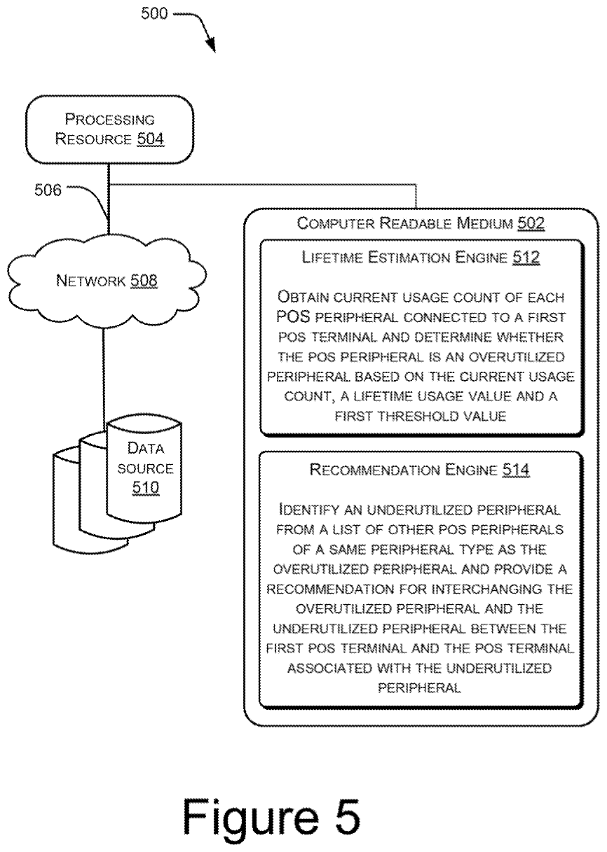

FIG. 5 illustrates an example network environment 500 using a non-transitory computer readable medium 502 for POS peripherals management, according to an example implementation of the present subject matter. The network environment 500 may be public networking environment or a private networking environment. In one example, the network environment 500 may include process resource 504 communicatively coupled to the non-transitory computer readable medium 502 through a communication link 506.

In an example, the processing resource 504 may be a processor of an electronic device, such as the POS management system 202 or the POS terminal 204. The non-transitory computer readable medium 502 may be, for example an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer readable medium 502 through a network 508. The network 508 may be a single network or a combination of multiple networks and may use a variety of communication protocols.

The processing resource 504 and the non-transitory computer readable medium 502 may also be communicatively coupled to data sources 510 over the network 508. The data sources 510 may include, for example, databases and computing devices. The data sources 510 may be used by the database administrators and other users to communicate with the processing resource 504.

In one example, the non-transitory computer readable medium 502 may include a set of computer readable instructions, such as a lifetime estimation engine 512, and a recommendation engine 514. As would be understood, the lifetime estimation engine 512 implements the functionality of the lifetime estimation engine 104, and the recommendation engine 514 implements the functionality of the recommendation engine 106. The set of computer readable instructions, referred to as instructions hereinafter, can be accessed by the processing resource 504 through the communication link 506 and subsequently executed to perform acts for facilitating facsimile communication.

For discussion purposes, the execution of the instructions by the processing resource 504 has been described with reference to various components introduced earlier with reference to the description of FIGS. 1-4.

On execution by the processing resource 504, the lifetime estimation engine 512 may obtain peripheral current usage count of each POS peripheral connected to a first POS terminal, such as the POS terminal 204-1. In one example, when the processing resource 504 is implemented by the POS terminal 204, the POS terminal 204 may obtain the peripheral data, such as the operational-days count and the lifetime usage value by monitoring the POS peripherals 206. In another example, when the processing resource 504 is implemented by the POS management system 202, the POS management system 202 may further obtain peripheral data, such as the operation-days count and the lifetime usage value from the POS terminal 204. In one example, the POS management system 202 may obtain peripheral data of the POS peripheral 206 from the POS terminal 204 on predefined intervals, such as hourly basis, twice a day, once a day. In another example, the POS management system 202 may obtain peripheral data of the POS peripheral 206 upon a request from the POS management system 202.

The lifetime estimation engine 512 may further determine for each POS peripheral 206, whether the POS peripheral 206 is an overutilized peripheral based on the current usage count of the POS peripheral 206, an operational-days count, a lifetime usage value, and a first threshold value. In one example, the overutilized peripheral may have an operational-days estimate value below a first threshold value. The operational-days estimate value may indicate the remaining number of days for which the POS peripheral is estimated to remain operational before exceeding the lifetime usage value. The first threshold value may represent a minimum number of days for which a POS peripheral is estimated to remain operational before exceeding the lifetime usage value to qualify as an average-utilized peripheral.

The recommendation engine 514 may further identify, for each overutilized peripheral, an underutilized peripheral from a list of other POS peripherals of a same peripheral type as the overutilized peripheral. In one example, the other POS peripherals are associated with POS terminals other than the first POS terminal. The overutilized peripheral has the operational-days estimate value greater than a second threshold value. In one example, the second threshold value may indicate a maximum number of days for which a POS peripheral is estimated to remain operational, before exceeding the lifetime usage value, to qualify as an average-utilized peripheral. For example, the second threshold value may be defined as 150 days, indicating that any POS peripheral having an operational-days estimate value of more than 150 days is underutilized.

The recommendation engine 514 may further provide a recommendation for interchanging the overutilized peripheral and the underutilized peripheral between the first POS terminal and the POS terminal associated with the underutilized peripheral. In one example, if it is determined that no underutilized peripheral of the same peripheral type is associated with other POS terminals 206, the recommendation engine 514 may ascertain if a POS peripheral of the same peripheral type is available in an inventory of the POS environment 200. The recommendation engine 514 may accordingly recommend replacing the overutilized peripheral with the POS peripheral available in inventory.

In another example, if it is determined that no underutilized peripheral of the same peripheral type is available in the inventory of the POS environment 200, the recommendation engine 514 may recommend ordering a new POS peripheral for replacing the overutilized peripheral.

In one example, the recommendation may be provided in the form of an audio/video message. In another example, the recommendation may be provided by an email. The recommendation may be provided to the POS terminal 204, POS management system 202, a display unit of the POS management system, or to an electronic device operated by the operator or the administrator of the POS management system 202.

Although examples for the present subject matter have been described in language specific to structural features and/or methods, it should be understood that the appended claims are not limited to the specific features or methods described. Rather, the specific features and methods are disclosed and explained as examples of the present subject matter.

1. A system comprising:
a processor;
a lifetime estimation engine coupled to the processor to:
receive peripheral data corresponding to a first set of point of sale (POS) peripherals connected to a first POS terminal; and
identify an overutilized peripheral from the first set of POS peripherals based on the peripheral data, the overutilized peripheral having an operational-days estimate value below a first threshold value; and
a recommendation engine coupled to the processor to:
identify an underutilized peripheral from a second set of POS peripherals connected to a second POS terminal, wherein the underutilized peripheral is of a same peripheral type as the overutilized peripheral, and wherein the underutilized peripheral has the operational-days estimate value greater than a second threshold value; and
provide a recommendation for interchanging the overutilized peripheral and the underutilized peripheral between the first POS terminal and the second POS terminal.

2. The system as claimed in claim 1, wherein the peripheral data for a POS peripheral comprises at least a current usage count of the POS peripheral, an operational-days count of the POS peripheral, peripheral type and a lifetime usage value of the POS peripheral.

3. The system as claimed in claim 2, wherein the lifetime estimation engine further is to:
calculate, for each POS peripheral, an average daily usage count based on the current usage count of the POS peripheral and the operational-days count of the POS peripheral; and
calculate the operational-days estimate value for the POS peripheral based on the average daily usage count, the current usage count of the POS peripheral, and the lifetime usage value of the POS peripheral.

4. The system as claimed in claim 3, wherein the lifetime estimation engine further is to:
compare, for each POS peripheral, the operational-days estimate value with the first threshold value and the second threshold value to determine whether the POS peripheral is overutilized, underutilized, or average-utilized;
for the POS peripheral having the operational-days estimate value between the first threshold value and the second threshold value, determine the POS peripheral as an average-utilized peripheral; and
recommend continued usage of the average-utilized peripheral with the first POS terminal.

5. The system as claimed in claim 1, wherein the recommendation engine further is to:
identify the peripheral type for the overutilized peripheral identified from the first set of POS peripherals;
obtain a list of POS peripherals, of the same peripheral type as the overutilized peripheral, associated with POS terminals other than the first POS terminal; and
identify the underutilized peripheral, from the list of POS peripherals, wherein the identified underutilized peripheral is from the second set of POS peripherals connected to the second POS terminal.

6. A method comprising:
obtaining peripheral data for each of a plurality of point of sale (POS) peripherals, wherein each POS peripheral is connected to a POS terminal, from among a plurality of POS terminals, the peripheral data for a POS peripheral comprising at least a current usage count of the POS peripheral, an operational-days count of the POS peripheral, and a lifetime usage value of the POS peripheral;
calculating, for each of the plurality of POS peripherals, an operational-days estimate value based on the current usage count of the POS peripheral, the operational-days count of the POS peripheral, and the lifetime usage value of the POS peripheral;
comparing, for each POS peripheral, the operational-days estimate value with a first threshold value to identify overutilized peripherals;
determining, for the overutilized peripherals, whether an underutilized peripheral of a same peripheral type as the overutilized peripheral is associated with POS terminals other than a POS terminal associated with the overutilized peripheral; and
providing a recommendation for replacing the overutilized peripheral based on the determining.

7. The method as claimed in claim 6, wherein the recommendation comprises at least one of:
interchanging the overutilized peripheral and the underutilized peripheral between the POS terminal associated with the overutilized peripheral and the POS terminal associated with the underutilized peripheral, if it is determined that the underutilized peripheral of the same peripheral type as the overutilized peripheral is associated with other POS terminals;
replacing the overutilized peripheral with a POS peripheral available in inventory, if it is determined that no underutilized peripheral of the same peripheral type as the overutilized peripheral is associated with the other POS terminals; and
ordering a new POS peripheral for replacing the overutilized peripheral, if it is determined that no underutilized peripheral of the same peripheral type as the overutilized peripheral is associated with the other POS terminals and that no peripheral of the same peripheral type is available in inventory.

8. The method as claimed in claim 6, wherein the determining comprises:
ascertaining the peripheral type for the overutilized peripherals;
for each of the overutilized peripherals, identifying other POS peripherals of the same peripheral type as the overutilized peripheral, wherein the other POS peripherals are associated with the POS terminals other than the POS terminal associated with the overutilized peripheral; and
comparing, for the identified POS peripherals, the operational-days estimate value with a second threshold value to identify underutilized peripherals, wherein the underutilized peripherals have the operational-days estimate value greater than the second threshold value.

9. The method as claimed in claim 6, wherein the calculating the operational-days estimate value comprises:
calculating, for each POS peripheral, an average daily usage count based on the current usage count of the POS peripheral and the operational-days count; and
calculating the operational-days estimate value for the POS peripheral based on the average daily usage count, the current usage count, and the lifetime usage value of the POS peripheral.

10. The method as claimed in claim 6, the method comprising:
monitoring, for each POS peripheral, usage of the POS peripheral; and
updating the current usage count of the POS peripheral upon each instance of usage of the POS peripheral.

11. The method as claimed in claim 6, further comprising:
comparing, for each POS peripheral, the operational-days estimate value with a second threshold value;
for the POS peripheral having the operational-days estimate value between the first threshold value and the second threshold value, determine the POS peripheral as an average-utilized peripheral; and
recommend continued usage of the average-utilized peripheral with the currently associated POS terminal.

12. A non-transitory computer readable medium having a set of computer readable instructions that, when executed, cause a processor to:
obtain a current usage count of each POS peripheral connected to a first POS terminal;
determine, for each POS peripheral, whether the POS peripheral is an overutilized peripheral based on the current usage count of the POS peripheral, an operational-days count of the POS peripheral, a lifetime usage value of the POS peripheral, and a first threshold value;
for each overutilized peripheral, identify an underutilized peripheral from a list of other POS peripherals of a same peripheral type as the overutilized peripheral, wherein the other POS peripherals are associated with POS terminals other than the first POS terminal; and
provide a recommendation for interchanging the overutilized peripheral and the underutilized peripheral between the first POS terminal and the POS terminal associated with the underutilized peripheral.

13. The non-transitory computer readable medium as claimed in claim 12, wherein the set of computer readable instructions, when executed, further cause the processor to:
calculate, for each POS peripheral, an average daily usage count based on the current usage count of the POS peripheral and the operational-days count;
calculate an operational-days estimate value for the POS peripheral based on the average daily usage count, the current usage count, and the lifetime usage value of the POS peripheral;
compare, for the POS peripheral, the operational-days estimate value with the first threshold value and a second threshold value to determine whether the POS peripheral is overutilized, underutilized, or average-utilized;
ascertain each POS peripheral having the operational-days estimate value below the first threshold value as the overutilized peripheral;
for each POS peripheral having the operational-days estimate value between the first threshold value and the second threshold value, determine the POS peripheral as an average-utilized peripheral; and
recommend continued usage of the average-utilized peripheral with the first POS terminal.

14. The non-transitory computer readable medium as claimed in claim 12, wherein the set of computer readable instructions, when executed, further cause the processor to:
ascertain the peripheral type for each overutilized peripheral;
for each overutilized peripheral, obtain the list of other POS peripherals of a same peripheral type as the overutilized peripheral; and
compare the operational-days estimate value of the other POS peripherals with a second threshold value to identify the underutilized peripheral corresponding to the overutilized peripheral, wherein the underutilized peripheral has the operational-days estimate value greater than the second threshold value.

15. The non-transitory computer readable medium as claimed in claim 12, wherein the set of computer readable instructions, when executed, further cause the processor to:
recommend replacing the overutilized peripheral with a POS peripheral available in inventory, if it is determined that no underutilized peripheral of the same peripheral type as the overutilized peripheral is associated with the other POS terminals; and
recommend ordering a new POS peripheral for replacing the overutilized peripheral, if it is determined that no underutilized peripheral of the same peripheral type is associated with the other POS terminals and that no POS peripheral of the same peripheral type is available in inventory.
